(19) United States
(12) Patent Application Publication
(10) Pub. No.: US 2024/0152199 A1
(43) Pub. Date: May 9, 2024

(54) LOW POWER CONTINUOUS DASHCAM RECORDING

(71) Applicant: Nexar Ltd., Tel Aviv (IL)

(72) Inventor: Lev Yitzhak Lavy, Misgav Dov (IL)

(21) Appl. No.: 18/412,649

(22) Filed: Jan. 15, 2024

Related U.S. Application Data
(63) Continuation-in-part of application No. 18/217,559, filed on Jul. 1, 2023.
(60) Provisional application No. 63/359,880, filed on Jul. 11, 2022.

(51) Int. Cl. G06F 1/3296; B60R 11/04

(52) U.S. Cl. CPC G06F 1/3296; B60R 11/04

(57) ABSTRACT

A system including an image sensor mounted on a vehicle, memory storing data captured by the image sensor, a buffer for temporarily storing data, an inertial measurement unit (IMU) that senses an impact on the vehicle, a switch connected to the image sensor, a main system on chip (SOC) connected to the image sensor via the switch, that stores data in the memory, the main SOC being in a dormant power mode while the vehicle is parked or idle, and in an active power mode while the vehicle is moving, and transitioning from dormant mode to active mode when the IMU senses that the vehicle suffers an impact, and a low-power secondary SOC microcontroller connected to the image sensor via the switch, that manages power of the system and stores data in the buffer, the buffer storing data that was captured prior to and upon the IMU detecting an impact.

### CROSS REFERENCE TO PRIORITY APPLICATION

This application is a continuation-in-part of U.S. patent application Ser. No. 18/217,559, entitled LOW POWER CONTINUOUS DASHCAM RECORDING, and filed on Jul. 1, 2023 by inventor Lev Yitzhak Lavy. U.S. patent application Ser. No. 18/217,559 is a non-provisional of U.S. Provisional Application No. 63/359,880, entitled LOW POWER CONTINUOUS DASHCAM RECORDING, and filed on Jul. 11, 2022 by inventor Lev Yitzhak Lavy, the contents of which are hereby incorporated herein in their entirety.

### FIELD OF THE INVENTION

The present invention relates to a power management system for low power continuous dashcam recording for vehicles, even while the vehicles are idle or parked.

### BACKGROUND OF THE INVENTION

A dashcam device is typically used by consumers and fleets for capturing collision and other incident evidence on the road. When a vehicle is idle, e.g., for the night, the dashcam switches to parking mode. Currently the parking mode user experience is very limited. For most cases the dashcam is installed by the driver and is connected to the cigarette lighter and not connected to the car battery, so the dashcam needs to use a small internal battery while parking. In case of impact an inertial measurement system (IMU) wakes the dashcam to collect evidence, and the dashcam starts capturing video footage only 3-10 seconds after impact time. Latency in capturing evidence, and the inability to capture data prior to the impact, results in vital evidence being missed, especially for incidents of hit-and-run and vandalism.

Reference is made to FIG. 1, which is a prior art power management system 100 for dashcams. System 100 includes nine primary components; namely, a system-on-chip (SOC) 110, a global navigation satellite system (GNSS) 120, an inertial measurement unit (IMU) 130, an image sensor 140, a microphone 150, a power management unit (PMU) 160, a long-term evolution (LTE) module 170, a short-range communicator 180, such as a Wi-Fi/BLUETOOTH® Low Energy (BLE) transmitter, and a secure digital (SD) non-volatile flash memory card 190.

PMU 160 controls SOC 110 and other components' power, and is triggered to wake up from sleep, when the vehicle is parked, by a dedicated pin connected to IMU 130, which is set to work in low-power mode, and only triggers PMU 160 on impact. While this mode potentially allows weeks of use if no trigger happens, as IMU 130 power is sub-Mw and the battery capacity is typically 300-600 Mah, it provides poor user experience due to the delay in capturing evidence. In prior art systems all of the evidence data sensing is controlled by SOC 110 and sent to output interface LTE 170/short-range communicator 180/SD card 190. The total power consumption on operational mode may jump from 200 Mw up to a few Watts on some dashcams. On some connected dashcams LTE 170 is also in standby mode, consuming up to a few Mw, and acts as another trigger.

### SUMMARY

Embodiments of the present invention provide a power management system for dashcams, overcoming the challenges of latency in capturing evidence, and the inability to capture data prior to the impact, and thus resolving loss of vital evidence. Embodiment of the present invention introduce an “always-on” mode.

The present invention relates to dashcams that are not hard-wired to a vehicle battery; as such, no special skill or installation is required to install them.

There is thus provided in accordance with an embodiment of the present invention a dashcam sticker that communicates with a main dashcam unit, including a housing mounted on a motor vehicle, an image sensor mounted on the housing, a memory mounted on the housing storing images captured by the image sensor, a short-range wireless transmitter mounted on said housing transmitting images stored in said memory to a primary dashcam unit, a power source mounted on the housing providing power to the image sensor, the memory, and the transmitter, the power source being operational in a high power mode and a low power mode, and a main control unit powered by the power source and operative to control the image sensor and the short-range wireless transmitter to capture images at a higher frame rate and transmit them to the primary dashcam unit at a higher bandwidth when the power source is in full power mode, and to capture images at a lower frame rate and transmit them to the primary dashcam unit at a lower bandwidth when the power source is in low power mode.

### BRIEF DESCRIPTION OF THE DRAWINGS

The present invention will be more fully understood and appreciated from the following detailed description, taken in conjunction with the drawings in which:

FIG. 1 is a prior art power management system for dashcams;

FIG. 2 is a simplified diagram of a low-power management system for dashcams, in accordance with an embodiment of the present invention;

FIG. 3 is a simplified schematic diagram of a motor vehicle having a main dashcam and several dashcam stickers, in accordance with an embodiment of the present invention;

FIG. 4 is a simplified block diagram of an overall system network architecture for a main dashcam and connected dashcam stickers, in accordance with an embodiment of the present invention;

FIG. 5 is a simplified block diagram of a solar-powered dashcam sticker, in accordance with an embodiment of the present invention;

FIG. 6 is a simplified block diagram of a dashcam sticker with a removable battery, in accordance with an embodiment of the present invention; and

FIG. 7 is a simplified block diagram of a dashcam sticker with a Wi-Fi+BLE module, in accordance with an embodiment of the present invention.

For reference to the figures, the following index of elements and their numerals is provided. Similarly numbered elements represent elements of the same type, but they need not be identical elements.

TABLE
of elements in the figures

| Element | Description |
|---|---|
| 100 | prior art power management system for a dashcam |
| 110 | system-on-chip (SOC) |
| 120 | global navigation satellite system (GNSS) |
| 130 | inertial measurement unit (IMU) |
| 140 | image sensor |
| 150 | microphone |
| 160 | power management unit (PMU) |
| 170 | long term evolution (LTE) module |
| 180 | short range communicator |
| 190 | a secure digital (SD) non-volatile flash memory card |
| 200 | novel power management system for a dashcam |
| 210 | main system-on-chip (MSOC) |
| 220 | secondary system-on-chip (SSOC) |
| 230 | switch |
| 240 | rolling buffer static random-access memory (SRAM) |
| 250 | monitor for temperature and battery level |
| 300 | motor vehicle |
| 400 | dashcam sticker system |
| 410 | cloud |
| 500 | main dashcam |

Table of elements in the figures (continued)

| Element | Description |
|---|---|
| 600 | dashcam sticker |
| 610 | solar panel |
| 620 | battery |
| 630 | BLUETOOTH® antenna |
| 640 | PCB |
| 650 | lens |
| 651 | infra-red LED |
| 652 | light sensor |
| 660- | removable battery |
| 670 | battery mount |
| 680 | short range communicator |
| 690 | MCU with vision capabilities |
| 691 | microphone |
| 692 | LED |
| 693 | battery |
| 694 | IMU |
| 695 | image sensor |
| 696 | environmental sensor |

### BRIEF DESCRIPTION OF THE TABLES

The present invention will be more fully understood and appreciated from the following detailed description, taken in conjunction with the tables in which:
TABLE I is an exemplary breakdown of always-on SSOC power consumption, in accordance with an embodiment of the present invention;
TABLE II is an exemplary comparison of features for a conventional dashcam in accordance with an embodiment of the present invention;
TABLE III is an exemplary escalating parking mode scheme, in accordance with an embodiment of the present invention;
TABLE IV is an exemplary comparison of configuration and buffer size, in accordance with an embodiment of the present invention;
TABLE V is an exemplary bill of materials for components of a dashcam sticker, in accordance with an embodiment of the present invention; and
TABLE VI is an exemplary tally of power consumption for components of a dashcam sticker, in accordance with an embodiment of the present invention.

### DETAILED DESCRIPTION

The present invention relates to dashcams that are not hard-wired to a vehicle battery; as such, no special skill or installation is required to install them. The present invention also relates to dashcams, which may or may not be connected to a vehicle battery, that operate in conjunction with dashcam stickers. In accordance with embodiments of the present invention, systems are provided for power management for dashcams, overcoming the challenges of latency in capturing evidence, and the inability to capture data prior to the impact, and thus resolving loss of vital evidence.

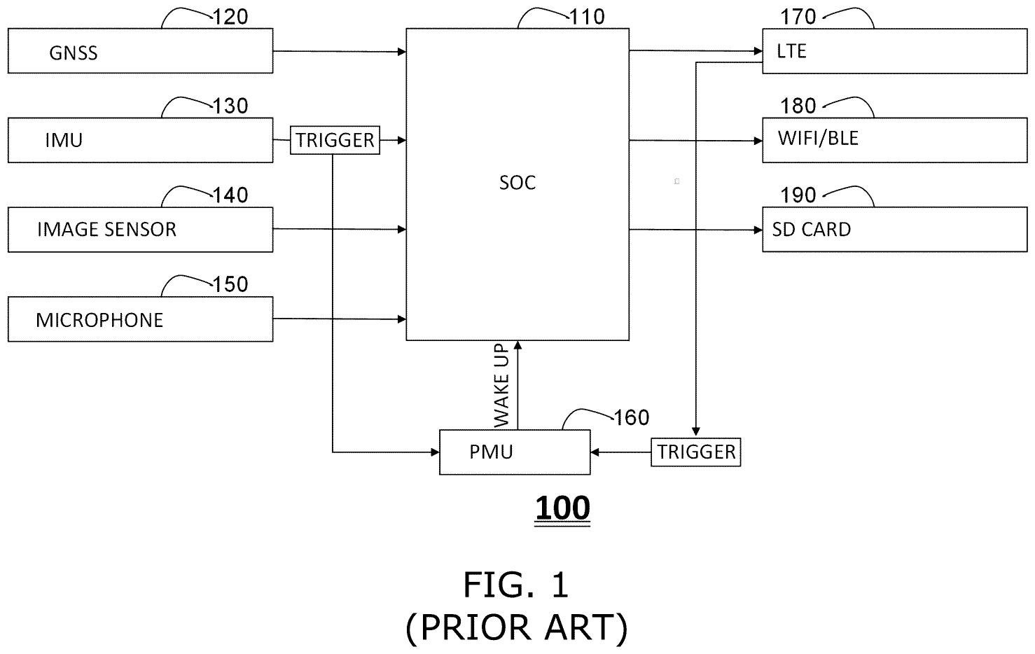

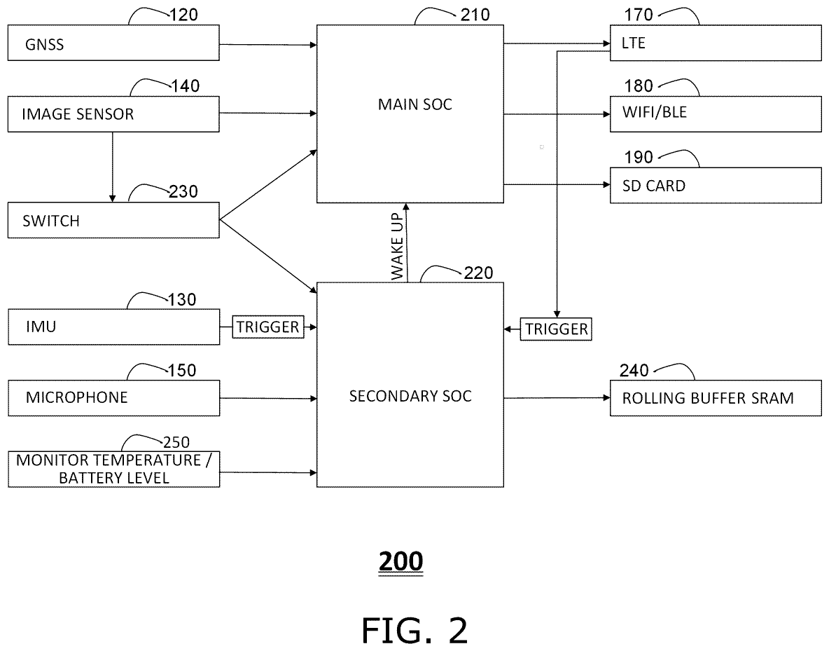

Reference is made to FIG. 2, which is a simplified diagram of a low-power management system 200 for dashcams, in accordance with an embodiment of the present invention. Instead of using one SOC 110 and a basic PMU 160 to control the dashcam, as in FIG. 1, system 200 is provided where all of the sensing components that are used for evidence in case of collision, theft or other incidents, are connected through an ultra-low power secondary SOC (SSOC) 220 that acts also as a power management solution and a logging device combined. System 200 further includes a switch 230, a rolling buffer SRAM 240, and a monitor 250 for temperature and battery level. System 200 for the dashcam brings the best from the low power logging device and the high power dashcam to create a new user experience.

In an embodiment of the present invention, SSOC 220 replaces the simple PMU microcontroller 160, to allow acting as an evidence collector. The low-power IMU 130 and microphone 150 are connected to SSOC 220. Image sensor 140 is switched between SSOC 220 and a main SOC (MSOC) 210 according to operation mode. An additional dedicated rolling buffer SRAM memory 240 is used to avoid activating the power-hungry SD card 190/main RAM and to avoid degrading their life span due to writing operations. In system 200 when moving to a new mode, which is referred to herein as the “always on” mode, SSOC 220 logs low fps, low resolution image sequence, audio and IMU 130 to rolling buffer 240 on the SRAM, and wakes up MSOC 210 if impact or other triggers are detected. Once MSOC 210 is woken up, SSOC 220 passes the recorded buffer to MSOC 210 as well as the camera control. Camera control switch 230 is fast, and MSOC 210 configuration of the camera takes a few ms to 100 ms, depending on image sensor 140. This approach allows smooth transition from low frame rate to high frame rate when MSOC 210 is running. and provides continuous evidence from before to after a parking incident.

Reference is made to TABLE I, which is an exemplary breakdown of always-on SSOC 220 power consumption, in accordance with an embodiment of the present invention. The total power is 41 Mw which is an order of magnitude less power compared to normal running mode. All of the values are taken from real used components.

System 200 introduces an “always on mode”, which enables providing evidence prior to a parking incident while still allowing long time operation.

Reference is made to TABLE II, which is an exemplary comparison of features for a conventional dashcam in accordance with an embodiment of the present invention. Specifically, TABLE II compares power consumption and features for a typical dashcam with 620 Mah 3.7V battery, 2300 Mw, where one uses a 48% power margin to accommodate the reduced performance over the device lifetime (1200 Mwh).

While a vehicle is driving, the normal operation mode is used to allow gathering highest detail and frame rate of visual evidence, and storing it on SD card 190 for a few hours' long rolling evidence. On parking the vehicle, to prevent battery drain in case of power off; e.g., a typical cigarette lighter charger in an electric car, or to prevent shortening life span of SD card 190 and other components in powered on connectors, such as hardwired kits, the dashcam switches to the always-on mode, during which the dashcam continues collecting evidence on a lower bandwidth and a shorter time window. Eventually when reaching low battery level, the always-on mode switches to connected parking mode, and eventually to deep parking mode. This is carried out in steps that take into account the power needed to wake up and write evidence to SD card 190 (about 1 min/20 Mw) or until the event ends and data is uploaded to the cloud (about 10 min/200 Mw).

If a battery level indicator is accessible to SSOC 220, quality degradation is finer; for example, from 30 fps 1080p on driving, to 5 fps 720p always-on when parking, to 1 fps 360p at 50%, and so on until full classic parking mode is set.

Reference is made to TABLE III, which is an exemplary escalating parking mode scheme, in accordance with an embodiment of the present invention. TABLE III shows an example of an escalating parking mode scheme.

In the exemplary scheme, a vehicle reaches a mode that fits most common computers during weekdays. During the weekend, the vehicle may fall back to connected or deep parking mode, to avoid total stop of protection.

### Implementation Details

Implementation of the always-on parking mode together with SSOC 220 takes many forms.
1. As SSOC 220+MSOC 210 combination where SSOC 220 replaces the role of PMU 160 and adds logging capabilities;
2. Where SSOC 220 is part of MSOC 210 as a subsystem within an SOC itself;
3. As an external unit/add on to the main dashcam, controlling the dashcam power externally and transmitting data wired or wirelessly;
4. SSOC 220 may be as a fully external device with its own sensors where the communication with MSOC 210 uses low power BLE where the offender management unit (OMU) on MSOC 210 is also BLE enabled;
5. SSOC 220 may be powered by a solar panel for years of operation instead of hours/days where it lasts the nights in low power mode; and
6. 360° coverage—In this mode a multiple dashcam array is used where each dashcam has a solar panel chosen to provide on daily average more than the low-power mode consumes. One of the dashcams is connected to power and runs in normal mode on driving. The solar powered dashcams continue running on low power always when BLE 180 is working. In case of an incident, the dashcam that is connected to the vehicle power wakes up others to obtain 360° evidence, and stream the evidence to the power connected dashcam for further processing. This mode may also be used without any connection to power where the solar or wind, or another low power input, dashcam sends data to the cloud.
7. 360° coverage: solar powered version—In this mode dashcam stickers without some of the dashcam components are used, in conjunction with a fully powered main dashcam. The MCU that controls the loop recording is connected to BLE, and cooperates with the main dashcam. In this mode, loop recording only records on SRAM/internal MCU memory, which may store up to 8 MB, thus enabling, e.g., one minute of loop recording at 5 frames per second VGA resolution of a JPEG image sequence. In case of a trigger by the main continuous power dashcam trigger or by the sticker dashcam internal detection using a limited MCU AI engine or other sensors, a high bandwidth communication module is awoken to pass data as well as another secondary flash for SOS events data. When the connected main dashcam has onboard diagnostics/fuse box wiring, in addition to the wired connected camera, all extended view cameras that are running on solar panels may also run sentry 24/7 mode by pushing data to the main dashcam.

There are many alternatives for power optimization that depend on actual modules used. Power modulation of different components is optimized according to the data rate and memory constraints, to allow operation in bursts and then moving back to idle.

In SSOC 220 connected components, there are three primary alternatives per component that collects evidence.
1. Connect directly to SSOC 220;
2. Switch between SSOC 220 and MSOC 210 depending on operation mode; and
3. Connect to MSOC 210, in case its power is too high, or not needed on the use cases for low power.

A typical configuration may be as such:
1. Connected to SSOC 220: Audio and IMU 130 are low power and low bandwidth, such that SSOC 220 streams them directly to MSOC 210 on normal operation mode, and to SRAM on low power;
2. Switched: Image sensor 140, the full operation video stream is too demanding for SSOC 220, so upon switching the camera is reconfigured to the proper operation mode to scale power and bandwidth according to the mode.
3. Connected to MSOC 210: GNSS 110, as for parking mode user case, one may assume that the vehicle is at the same location as last observed, due to the high power of the component.

To provide images that fit the always on small SRAM size, it is preferable to avoid raw data output and use image sensors that produce JPEG images or another compressed format. In addition, it is important to use sensors where the power consumption is linear, as much as possible, with frame rate and resolution. When using flash memory, which can be considerably larger at the same cost, raw data format is also a factor.

Interface support of image sensor 140 matches SSOC 220 and MSOC 210, to allow switching between them. In some implementations of the present invention, switch 230 is optional and SSOC 220 itself is the switch, passing data through in driving while logging it in parking mode. In these embodiments, image sensor 140 is connected to SSOC 220, and SSOC 220 passes data to MSOC 210 instead of using switch 230.

An alternative embodiment of the present invention for power saving is to use multiple low resolution, ultra-low power image sensors 140, and create a dashcam large field of view using more than one lens. This embodiment has following advantages:
1. Modulating the sampling between image sensors 140 to get cheaper and low power cameras to produce a wide field of view.
2. Use of a basic motion tracking to increase fps only for a relevant image sensor 140, thus providing smoother video on area of interest. This embodiment may also be used with a high FOV high resolution dashcam having a setting for area of interest, but with smaller impact on power.
3. Obtain thinner design of the dashcam as multiple image sensors 140 that are slightly different at angle provide a needed FOV with smaller lenses.

Another embodiment of the present invention uses two image sensors 140; namely, one low end low power image sensor 140 for always-on, and another image sensor 140 for driving mode, whereby upon impact SSOC 220 immediately switches to the high-end image sensor 140 until MSOC 210 is up and running.

In an alternative embodiment of the present invention, a single low power image sensor 140 with low resolution and FOV is equipped with a tiny motor to allow rotation around a selected axis or multiple axes, where in parking mode image sensor 140 immediately changes orientation according to a direction of impact as observed by IMU 130, or by using other low power detection means, such as low power radar.

The always-on parking mode may also be used to allow in-driving. to prevent reaching a state of overheat and camera shut down. By monitoring camera temperature, either from IMU 130 or from another source (battery/SOC/dedicated sensor), the device detects in advance that overheat is trending, and switches to the always-on mode to allow cooling while continuing to collect data. This can be either modulation of normal and always-on mode, or a full switch to always-on until full cooldown is reached. In always-on mode. collision detection algorithms run on IMU 130 data to provide improved detection confidence compared to threshold-based methods.

Monitor 250 monitors dashcam temperature and power level in low power mode using SSOC 220 to modulate its operation, or runs continuously if its power consumption is low enough. The temperature and battery level are logged to rolling buffer 240 for later use and inspection.

In addition to logging ability that the always-on mode provides, algorithms that provide improved triggering as compared to the conventional threshold-based G-impact detection, are run. This is based on time series analysis of the acceleration and audio signals, and training of tiny AI models.

There are three main factors for selecting rolling buffer memory module 240:
1. Size
2. Power consumption
3. Durability

Size considerations are the window of time before the event trigger that is needed, which is denoted by time_{back}. The time that takes MSOC 210 to load its firmware and be able to smoothly take over the camera, is denoted timeᵤₚ. As such, the overall time window is time_{back}+timeᵤₚ. The desired frame rate and resolution of the image sensor, audio bitrate and IMU 130 frequency add up together to be the buffer-bitrate.

Reference is made to TABLE IV, which is an exemplary comparison of configuration and buffer size, in accordance with an embodiment of the present invention. The example in TABLE IV corresponds to configurations and required buffer sizes for time_{back}=10 seconds and timeᵤₚ=10 seconds, total of 20 seconds time window for rolling buffer 240.

Alternatives for these sizes include inter alia CMOS, flash, SRAM

Power consumption alternatives are:
1. Active power consumption;
2. Option for sleep/deep sleep; and
3. Time of modulation between modes.

Since rolling buffer 240 fully rewrites every window of operation, typically 3 times per min., durability of memory is an important factor. This factor favors SRAM-type solutions. If NAND flash is used, the size should be a factor of at least 100×, depending on the flash write durability cycles, to avoid a high rate of errors.

To lower use of SRAM, which is more expensive than flash memory, a combination of those types may be used, whereby the SRAM is used for rolling buffer 240 up to the point of event trigger, and afterwards SD card 190 or flash may be used instead. This avoids write cycles on the less durable memory types, and allows unrestricted load time for MSOC 210.

To allow reaching optimal power saving with buffer memory for the evidence, if the memory device, such as SRAM, supports sleep/deep sleep with fast operation mode change, usually sub-ms, the modes may be modulated to reach a high level of power reduction.

To achieve the above, SSOC 220 buffers on its own memory the audio and IMU 130 in-between image frames. This allows a burst of data write to SRAM and returning to sleep/deep sleep mode with order of magnitude less power. At 3 fps video, the audio size for a third of a second, on 44 Khz, 12 bit mono is 23 KB, so this is a requirement on SSOC 220 cache size, as for IMU 130 for six degrees of freedom (DOF). Accelerometer and gyro at 50 Hz provide 0.2 KB, such that this is not an issue. Thus, on new images available SRAM is awakened, passed IMU 130 and audio data, pass through the image, and then set back to sleep. The burst mode may be used to push SSOC 220 power down using modulation of mode on SSOC 220 itself where it goes to sleep between images from image sensor 140, and image sensor 140 triggers an SSOC interrupt to allow SSOC 220 to fetch a new image, where the same may happen with IMU 130 with the first-in-first out (FIFO) capability that allows internal storage and pass of data in bursts every 1 second, depending on FIFO size and frequency. For audio, a specific module with buffering capabilities is used as well, or alternatively this capability for power savings is omitted.

When each sensing module has its own internal cache and SSOC 220 has limited internal storage, an alternative embodiment of the present invention operates with interrupts from each sensing module, when SSOC 220 cache is full, that wake up both SSOC 220 and the storage, to allow asynchronous burst mode while still lowering overall power consumption.

Embodiments with analog sensors use analog-to-digital (ADC) converters that have internal memory, and optionally send an interrupt to SSOC 220 to mimic the sensors with the FIFO option. These embodiments are of advantage for audio input, which generally lacks buffering capability, to obtain burst mode operation both on SSOC 220 and the storage device.

For low power mode of always-on, wind/solar and another wireless power source may be used to extend operation, or to allow it to be re activated periodically.

When considering the solar power panel and the fact that the dashcam is placed toward the road/cabin and has a mount placed on the windshield, the mount may have a solar panel with a transparent adhesive or suction cup.

For an always-on power consumption of 40 Mwh, the needed solar panel size in places like California with six peak sun hours is 6 W with an off the shelf 11×6 cm 1 W rated panel on idle conditions. Since the panel for this example is in the mount, this reduces to about 25% according to direction of parking to about 250 Mw, with 40 Mw consumption per hour. This suffices not only to power the dashcam during daylight with always-on mode, but also to allow charging the dashcam battery for overnight classic parking mode. For use cases like back of a truck where solar panel size is not restricted and panels may be ideally placed, one reaches a few W average per day and the “always on” operation with a dashcam that is fully wireless with 3 W solar panel rating.

Always-on mode opens many new multi-camera configurations with minimal setup complexity where only one or even none of the dashcams needs wiring. This is possible using solar or other low power charging methods, like nuclear battery, that allow long low power output operation. The dashcams run on low power always-on mode and are activated from a main dashcam/LTE trigger/motion sensor/radar/touch or another source, and may wake each other up to record evidence and upload it either individually or using the main dashcam as a gateway.

### Dashcam Stickers

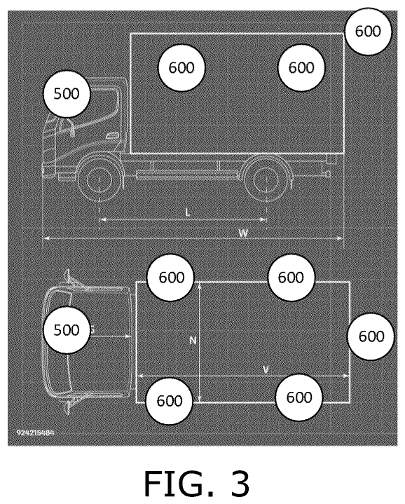

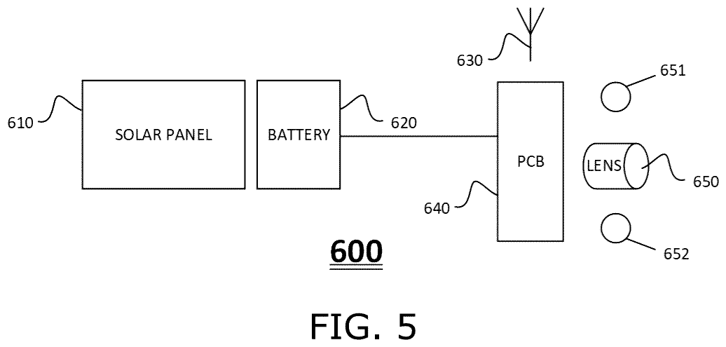

Reference is made to FIG. 3, which is a simplified schematic diagram of a motor vehicle 300 having a main dashcam 500 and several dashcam stickers 600, in accordance with an embodiment of the present invention. The embodiment of FIG. 3 may be used for fleets of trucks. Main dashcam 500 provides road-facing and cabin-facing views. Dashcam stickers 600 provide side views. Main dashcam 500 and dashcam stickers 600 may be installed by a driver of motor vehicle 300, without drilling. A current bill of materials for the configuration shown in FIG. 5 is approximately $500, which is significantly cheaper than conventional truck installations. TABLE V shows an exemplary bill of materials for a dashcam sticker.

A dashcam sticker 600 may be placed within a vehicle as well as the rear deck or rear window. It may be also mounted with a magnet or strip. It may also be purely battery powered with a battery that may be removed for home/office charging. A dashcam sticker does not require an SOC or an SD card, which substantially reduces its cost. The MCU/SSOC in a dashcam sticker function alone and aggregate either (i) directly to the cloud, using long-range communication such as LTE, or (ii) to main dashcam 500 using short-range communication such as BTE. To conserve power the MCU switches power modes between (i) running AI, high frames per second and Wi-Fi transmission for high bandwidth, as in a case of impact detection, to (ii) only low frames per second and 1 frame per second BLE image stream to the main dashcam, or other modes described hereinabove. For transmitting evidence in case of a collision event, the MCU may run a power mode whereby a dashcam sticker camera performs internal loop recording at low frames per second, while continuing to analyze an inertial measurement unit.

A dashcam sticker may be placed in any location outside of a vehicle, e.g., on a property gate, or on an entry to a company parking lot, or in a public domain, so that when a car passes near it, the driver obtains an external view. In such case video footage may be set to be shared with all vehicles in a broadcast stream.

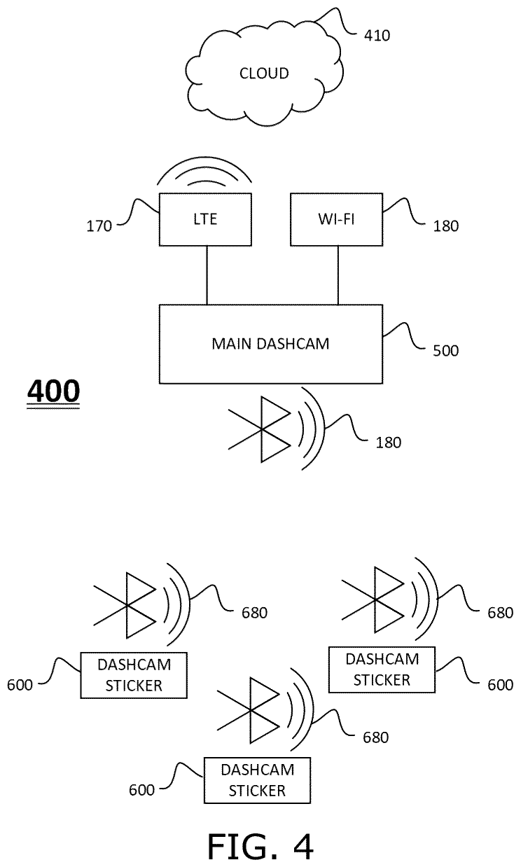

Reference is made to FIG. 4, which is a simplified block diagram of an overall system 400 network architecture for a main dashcam and connected dashcam stickers, in accordance with an embodiment of the present invention. System 400 includes a main dashcam 500 with BTE, LTE and Wi-Fi connections, three dashcam stickers 600 with BTE connections, and a cloud 410.

Main dashcam 500 may or may not be connected to a battery of motor vehicle 300. When dashcam 500 is connected to a battery of motor vehicle 300, each dashcam sticker 600 may act as a security camera and provide 24/7 coverage, if main dashcam 400 continues operating with the battery of vehicle 300 while vehicle 300 is parked.

Each dashcam sticker 600 has MCU SRAM with up to 8 MB of storage. As such, the SRAM may store up to 20 seconds of 500×500 pixel image data captured at 5 frames per seconds, together with audio data and IMU data, assuming 20 KB per JPEG image, with memory remaining for AI processing.

Each dashcam sticker 600 transmits at up to 100 Kb per second, and is thus able to transmit 1 frame per second to main dashcam 600 via BLE. One BLE5 connection may support up to 6 dashcam stickers. Additional cameras may be supported if time lapse is modulated between them. When an event is triggered, approximately 5 seconds of data on a dashcam sticker 600 is locked until it is uploaded to main dashcam 500.

Depending upon battery level, each dashboard sticker 600 may run AI at for simple object detection. In a sentry mode, each dashcam sticker 600 acts as a security camera and runs artificial intelligence (AI) processing at 1 frame per second to detect motion or human presence, which may include out of sight detection using a microphone. As such, AI is not limited to running just on vision, but may also run on audio.

Reference is made to FIG. 5, which is a simplified block diagram of a solar-powered dashcam sticker 600, in accordance with an embodiment of the present invention. Shown in FIG. 5 is a solar panel 610 connected to a battery 620. Also shown in FIG. 5 are a BLUETOOTH® antenna 630, and a PCB 640 with a lens 650 that has an infra-red LED 651 and a light sensor 652. PCB 640 has an MCU, an IMU, a microphone and an image sensor mounted thereon. Lens 650 may be angled by using multiple plastic mounts. Battery 620, antenna 630, lens 650, LED 651 and light sensor 652 may be mounted on PCB 640.

To allow operation in most areas, with a 15×15 cm² solar panel, power consumption needs to be low, under 100 mw. TABLE VI shows power consumption for a minimum power operational mode and a maximum power operational mode, in accordance with an embodiment of the present invention. The operational mode is set based on available battery level.

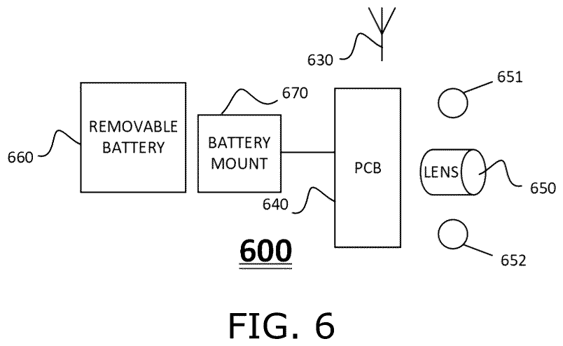

Reference is made to FIG. 6, which is a simplified block diagram of a dashcam sticker 600 with a removable battery, in accordance with an embodiment of the present invention. Shown in FIG. 6 is a removable battery 660 and a battery mount 670, together with PCB 640 with lens 650 that has infra-red LED 651 and light sensor 652. PCB 640 has an MCU, an IMU, a microphone and an image sensor mounted thereon. The camera with lens 650 may be angled by using multiple plastic mounts, and may be rotated internally.

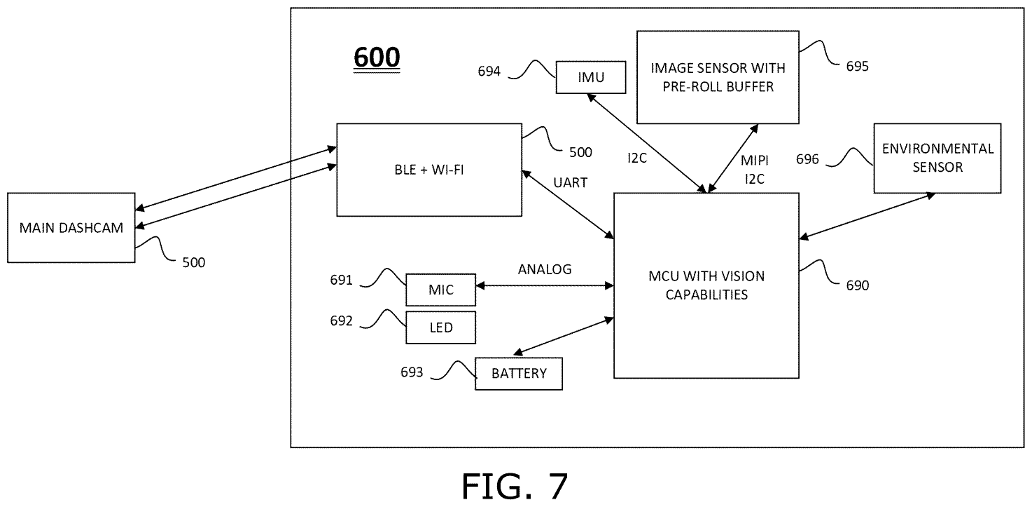

Reference is made to FIG. 7, which is a simplified block diagram of a dashcam sticker 600 with a Wi-Fi+BLE module, in accordance with an embodiment of the present invention. As shown in FIG. 7, dashcam sticker 600 incudes a short-range communicator 680, such as a Quectel Wi-Fi+BLE transmitter. Communicator 680 transmits data to and receives data from main dashcam 500. Communicator 680 uses BLE to run on low power, and uses Wi-Fi for data burst upload. Communicator 680 has 8 MB of Flash memory, thus enabling loop recording on WE2 to push data rapidly for Wi-Fi transmission in case an event is triggered, while it continues performing the loop recording.

Regarding performance, the BLE transmission provides a low bandwidth data stream that may incorporate 1 frame per second of JPEG image data, together with IMU data. The Wi-Fi transmission enables a data burst in response to trigger of an event, providing 5 frames per second of JPEG image data, together with audio data and IMU data, for a short time of operation.

Communicator 680 is connected to an MCU processor 690 with vision capabilities. MCU processor 690 may be, for example, a WE1 or WE2 processor from Himax Technologies, Inc., or an E1, E2, E3 or B1 processor from Alif Semiconductor. The Alif B1 processor includes a short-range communicator 680. Other components connected to MCU processor 690 include an analogue microphone 691, an LED 692, a battery 693, an IMU 694, an image sensor 695, and an environmental sensor 696. Image sensor 695 may be, for example, a Silicon Optronics, Inc. image sensor with a pre-roll buffer. Environmental sensor 696 may be, for example, a gas sensor, which operates at low power.

MCU processor 690 may perform AI processing on images captured by image sensor 695 and on audio captured by microphone 691. The AI processing is used inter alia to switch between power modes. The AI processing may also be used to determine an optimal region of interest, thereby enabling automatically selecting a best area for effectively zooming in to the region of interest and thereby capturing a better view of the relevant area. Such AI processing is of particular advantage when image sensor 695 is a high-resolution sensor, and the region of interest may be changed dynamically when the motor vehicle transitions from parking to driving and vice versa.

In the foregoing specification, the invention has been described with reference to specific exemplary embodiments thereof. It will, however, be evident that various modifications and changes may be made to the specific exemplary embodiments without departing from the broader spirit and scope of the invention. Accordingly, the specification and drawings are to be regarded in an illustrative rather than a restrictive sense.

### TABLES

TABLE I
Always-On Mode SSOC Power Consumption Breakdown

| Component | Power | Function | Comments |
|---|---|---|---|
| SSOC | 20 Mwh | Save data to the | Selected ssoc performance |
| | | SRAM/control the | requirement are very low |
| | | rolling buffer. | and compute is about 50 |
| | | Wake up the | MHz. |
| | | MSOC on trigger. | |
| SRAM | 5 Mwh | Store the rolling | Original power is 20 mw |
| | | buffer. | and lower power is |
| | | | obtained by modulating |
| | | | on/standby by when new |
| | | | frame arrives from the |
| | | | image sensor. |
| IMU | 0.1 Mwh | Provide evidence | In case of low battery |
| | | in case of collision, | level and move to the |
| | | direction of hit, | deep/connected parking |
| | | severity. Provide a | mode, the IMU also |
| | | trigger for the | wakes up the SSOC. |
| | | SSOC to pass and | |
| | | wake the MSOC. | |
| Microphone | 1 Mwh | Audio evidence. | Mono. |
| Temperature | 0.1Mwh | Provide battery | Critical component to |
| and battery | | level and | allow flexible use of the |
| level sensor | | temperature for | battery and protecting |
| | | smart mode | the device. |
| | | switching. | |
| Image | 6 Mwh | Provide basic | 1-3 fps 720/480 p |
| sensor | | vision evidence. | resolution with jpg output |
| | | | format. |
| LTE | 9 Mwh | Allow activating | LTE will work in standby |
| | | the camera from | mode to pick up wake up |
| | | the customer | requests only. |
| | | phone/remote | |
| | | service. | |

TABLE II
Comparison of Power Consumption and Dashcam Features

| | | | | Main | |
|---|---|---|---|---|---|
| Power | Use | Power | Operation | operational | |
| mode | case | consumption | duration | components | Evidence |
| Normal | Driving | 1200 Mwh | 1 h | MSOC, RAM, | 1080 p 30 fps |
| | | | | GNSS, LTE, | video, dual |
| | | | | Wi-Fi, BLE, | audio, 200 Hz |
| | | | | Image | IMU, 10 Hz |
| | | | | sensor, IMU, | location. prior |
| | | | | microphone, | evidence |
| | | | | SSOC | according to SD |
| | | | | | card capacity. |
| Always | Parking, | 41 Mwh | 30 hours | SSOC, SRAM, | 720 p 3 fps, |
| on | overheat | | | IMU, LTE | 50 Hz IMU, |
| | protection | | | (standby) | mono audio 20 |
| | | | | | seconds prior |
| | | | | | event. |
| Connected | Long | 10 Mwh | 5 days | SSOC, IMU, | Normal mode 10 |
| parking | range | | | LTE | seconds after |
| mode | parking | | | (standby) | the event. |
| Deep | Low | 1 Mwh | 50 days | SSOC, IMU | Normal mode 10 |
| parking | battery | | | | seconds after |
| mode | survival | | | | the event. |

TABLE III
Escalating Parking Mode Scheme

| State | Remaining power (Mwh) | Duration |
|---|---|---|
| Initial state, entering | 1200 | 0 |
| parking | | |
| Always on mode | 500 | 17 hours |
| Connected parking | 300 | 20 hours |
| mode | | |
| Deep parking mode | 200 | 100 hours |

TABLE IV
Exemplary Configurations and Buffer Sizes

| Configuration | | | | |
|---|---|---|---|---|
| type | Video | Audio (mono) | IMU 3DOF | Total size |
| Low definition | 2 FPS | 12 Khz | 25 Hz | 1.2 MB |
| | 60 p | 12 bit | 16 bit | |
| | 40 KBS | 18 KBS | 0.15 KBS | |
| Medium | 3 FPS | 44 Khz | 50 Hz | 3.6 MB |
| definition | 480 p | 12 bit | 16 bit | |
| | 120 KBS | 66 KBS | 0.3 KBS | |
| High definition | 5 fps | 48 KHz | 100 Hz | 12 MB |
| | 720 p | 16 bit | 16 bit | |
| | 500 KBS | 100 KBS | 0.6 KBS | |

TABLE V
Dashcam Sticker Bill of Materials

| Unit | Cost ($) |
|---|---|
| MCU with vision capabilities | 5 |
| Pre-roll image sensor | 3 |
| Lens | 2 |
| IMU | 1 |
| Mic | 1 |
| BLE | 1 |
| Battery | 5 |
| Solar Panel | 5 |
| Plastics | 5 |
| Assembly | 3 |
| R-BOM | 5 |
| TOTAL | 36 |

TABLE VI
Dashcam Sticker Power Consumption

| | Max Power (mw) | Min Power (mw) |
|---|---|---|
| | 5 FPS + AI + streaming | 1 FPS |
| MCU loop recording | 10 | 10 |
| MCU AI | 25 | 0 |
| Microphone | 1 | 1 |
| IMU | 1 | 1 |
| BLE | 20 | 0 |
| TOTAL | 62 | 14 |

What is claimed is:

1. A dashcam sticker that communicates with a main dashcam unit, comprising:
a printed circuit board (PCB) in a housing mounted on a motor vehicle;
a memory mounted on said PCB;
an image sensor mounted on said PCB, operative to capture images in a field of view and to store the captured images in said memory;
a short-range wireless transmitter mounted on said PCB operative to transmit image data for images stored in said memory to a primary dashcam unit also mounted on the motor vehicle;
a power source mounted on said PCB providing power to said image sensor, said memory, and said short-range wireless transmitter, the power source being operational in a high-power mode and a low-power mode; and
a micro-control unit (MCU) mounted on said PCB, powered by said power source, and operative to control said image sensor and said short-range wireless transmitter to capture images at a higher frame rate and transmit image data to the primary dashcam unit at a higher bandwidth when said power source is in high-power mode, and to capture images at a lower frame rate and transmit image data to the primary dashcam unit at a lower bandwidth when said power source is in low-power mode.

2. The dashcam sticker of claim 1 wherein said power source comprises a solar power source comprising a solar panel.

3. The dashcam sticker of claim 1 wherein said power source comprises a wind power source.

4. The dashcam sticker of claim 1 wherein said power source comprises a removable battery.

5. The dashcam sticker of claim 1 said MCU controls said short-range wireless transmitter to transmit image data via Bluetooth at the lower bandwidth, and to transmit image data via Wi-Fi at the higher bandwidth.

6. The dashcam sticker of claim 1 wherein said memory comprises:
SRAM memory; and
non-volatile memory,
and wherein said MCU controls said image sensor to down-sample captured pixel images in a pre-roll buffer written to said SRAM memory when said power source is in low-power mode.

7. The dashcam sticker of claim 1 further comprising a microphone mounted on said PCB, operative to capture audio, and store the captured audio in said memory, wherein said MCU is further operative to control said microphone and said short-range wireless transmitter to transmit audio data for audio stored in said memory to the primary dashcam.

8. The dashcam sticker of claim 7 wherein audio data triggers said MCU to run in high-power mode.

9. The dashcam sticker of claim 7 wherein said MCU performs artificial intelligence processing on images captured by said image sensor on an audio captured by said microphone.

10. The dashcam sticker of claim 1 further comprising an inertial measurement unit (IMU) mounted on said PCB, operative to capture both audio data and inertial measurement data, and store the captured audio in said memory, wherein said MCU is further operative to control said IMU and said short-range wireless transmitter to transmit the captured audio data and inertial measurement data to the primary dashcam.

11. The dashcam sticker of claim 1 further comprising an environmental sensor mounted on said PCB, operative to sense environmental data, wherein said MCU is further operative to control said environmental sensor and said short-range wireless transmitter to transmit environmental data to the primary dashcam.

12. The dashcam sticker of claim 11 wherein said environmental sensor is a gas sensor.

13. The dashcam sticker of claim 1 further comprising a long-range wireless transmitter, wherein said MCU is further operative to control said long-range wireless transmitter to transmit image data to a cloud server.

14. The dashcam sticker of claim 1 wherein said image sensor comprises a light source, and wherein said light source is synchronized to image capture.

15. The dashcam sticker of claim 1 wherein said MCU sets said image sensor to a minimal power mode, and increases power of said image sensor in response to detection of a human presence.

16. The dashcam sticker of claim 1 wherein said MCU performs artificial intelligence processing to find an optimal region of interest for said image sensor to capture images.

17. A dashcam sticker that communicates with a cloud computer, comprising:
a printed circuit board (PCB) in a housing mounted on a motor vehicle;
a memory mounted on said PCB;
an image sensor mounted on said PCB, operative to capture images in a field of view and to store the captured images in said memory;
a wireless transmitter mounted on said PCB operative to transmit image data for images stored in said memory to a cloud computer;
a power source mounted on said PCB providing power to said image sensor, said memory, and said wireless transmitter, the power source being operational in a high-power mode and a low-power mode; and
a micro-control unit (MCU) mounted on said PCB, powered by said power source, and operative to control said image sensor and said wireless transmitter to capture images at a higher frame rate and transmit image data to the cloud computer at a higher bandwidth when said power source is in high-power mode, and to capture images at a lower frame rate and transmit image data to the cloud computer at a lower bandwidth when said power source is in low-power mode.
